(19) United States
(12) Patent Application Publication
(10) Pub. No.: US 2025/0239720 A1
(43) Pub. Date: Jul. 24, 2025

(54) RECHARGEABLE BATTERY

(71) Applicant: SAMSUNG SDI CO., LTD., Yongin-si (KR)

(72) Inventors: Munsung KIM, Yongin-si (KR); Juyeon KIM, Yongin-si (KR); Hyunki JUNG, Yongin-si (KR)

(21) Appl. No.: 18/779,215

(22) Filed: Jul. 22, 2024

(30) Foreign Application Priority Data
Jan. 23, 2024 (KR) 10-2024-0010457

(51) Int. Cl. H01M 50/342; H01M 50/124; H01M 50/129; H01M 50/152; H01M 50/193; H01M 50/198

(52) U.S. Cl. CPC H01M 50/3425; H01M 50/1245; H01M 50/129; H01M 50/152; H01M 50/193; H01M 50/198

(57) ABSTRACT

A rechargeable battery includes an electrode assembly, a can, a cap plate, and a heat dissipating portion. The electrode assembly includes a first electrode, a separator, and a second electrode. The can accommodates the electrode assembly in an internal space. The cap plate is coupled to an open end of the can to close the can, and the cap plate is provided with a notch groove and at least one opening positioned at a distance from the notch groove. The heat dissipating portion at least partially fills the opening.

### CROSS-REFERENCE TO RELATED APPLICATION

This application claims priority to and the benefit of Korean Patent Application No. 10-2024-0010457 filed in the Korean Intellectual Property Office on Jan. 23, 2024, the entire contents of which are incorporated herein by reference.

### BACKGROUND OF THE DISCLOSURE

### (a) Field of the Disclosure

The present disclosure relates to a rechargeable battery. For example, the present disclosure relates to a structure of a rechargeable battery to improve high temperature safety.

### (b) Description of the Related Art

Rechargeable batteries are used for a variety of purposes, such as powering small electronic devices such as mobile phones and laptop computers, and powering motors for transportation vehicles such as electric vehicles and hybrid vehicles. In the latter case, a battery module combining a plurality of cylindrical rechargeable batteries may be used. A cylindrical rechargeable battery may have an enlarged electrode assembly diameter to secure a large capacity.

A hot-box is a safety evaluation item for rechargeable batteries and can be used to evaluate a rechargeable battery by placing it in a chamber, raising a temperature of the chamber to 130° C., and maintaining it for 30 minutes. Previously, in order to satisfy hot box safety evaluations, heat generation by the electrode assembly was controlled by improving the positive and negative electrodes materials. However, in the case of high-capacity materials, heat generation begins at a relatively lower temperature, so it becomes more difficult to satisfy the hot box safety evaluations as the rechargeable battery becomes larger.

### SUMMARY OF THE DISCLOSURE

The present disclosure provides a rechargeable battery that can improve high temperature safety by discharging internal heat when the internal temperature of the rechargeable battery exceeds a predetermined temperature.

A rechargeable battery according to an embodiment includes an electrode assembly, a can, a cap plate, and a heat dissipating portion. The electrode assembly includes a first electrode, a separator, and a second electrode. The can accommodates the electrode assembly in an internal space. The cap plate is coupled to an end of the open side of the can to close the can and the cap plate has a notch groove and at least one opening positioned at a distance from the notch groove. The heat dissipating portion at least partially fills the opening.

The cap plate may include a first part, a second part, and a first opening positioned between the first part and the second part. The heat dissipating portion may seal the first opening and integrally combine the first and second parts. The first part may be positioned in the center of the cap plate, the heat dissipating portion may be formed in a ring shape surrounding the first part, and the second part may surround the heat dissipating portion. The notch groove may be positioned on the second part.

A plurality of additional openings with a circular arc shape may be positioned on the cap plate, and the heat dissipating portion may include a plurality of heat dissipating portions to seal each of the plurality of additional openings. The plurality of heat dissipating portions may be arranged along a circle centered on the center point of the cap plate, and the notch groove may be positioned to surround the plurality of heat dissipating portions.

A cross-shaped opening may be positioned on the cap plate, and the heat dissipating portion may seal the cross-shaped opening. The center of the heat dissipating portion may coincide with the center of the cap plate, and the notch groove may be positioned to surround the heat dissipating portion.

A circular opening may be positioned on the cap plate, and the heat dissipating portion may seal the circular opening. The center of the heat dissipating portion may coincide with the center of the cap plate, and the notch groove may be positioned to surround the heat dissipating portion.

The heat dissipating portion may include a polymer material that is melted at 80° C. to 130° C. The heat dissipating portion may include one or more polymers chosen from polystyrene (PS), low density polyethylene (LDPE), high density polyethylene (HDPE), and acrylonitrile butadiene styrene (ABS).

A rechargeable battery according to another embodiment includes an electrode assembly, a can, a cap plate, and a heat dissipation film. The electrode assembly includes a first electrode, a separator, and a second electrode. The can includes a bottom portion and a side portion, and the can accommodates the electrode assembly in an internal space surrounded by the bottom portion and the side portion. The cap plate is coupled to the end of the side portion to close (e.g., seal) the can. At least one opening filled with a polymer material for discharging internal heat and gas during melting and a notch groove surrounding the opening may be provided in the cap plate. The heat dissipation film may be attached to the outer surface of the side portion.

The polymer material may be melted at 80° C. to 130° C. The heat dissipating portion may include one or more polymers chosen from polystyrene (PS), low density polyethylene (LDPE), high density polyethylene (HDPE), and acrylonitrile butadiene styrene (ABS).

The opening may be provided on the center of the cap plate in a circular ring shape, a cross shape, or a circle shape. The opening includes a plural of openings that are spaced apart from each other to form a circle.

The heat dissipation film may include at least one heat dissipation layer and a plurality of polymer layers that protect the heat dissipation layer. The heat dissipation layer may include aluminum, copper, and/or carbon nanotubes, and each of the plurality of polymer layers may include one or more polymers chosen from polyimide, polyethylene terephthalate, oriented polystyrene, oriented polypropylene, and polyethylene naphthalate.

The rechargeable battery of embodiments may gradually discharge internal heat by melting of the heat dissipating portion when being exposed to a high temperature outside the normal range, and when a rapid increase in the temperature and pressure occurs, the cap plate may be broken, thereby discharging a large amount of heat at once. The rechargeable battery of embodiments may improve high temperature safety by improving heat dissipation characteristics of the rechargeable battery.

### BRIEF DESCRIPTION OF THE DRAWINGS

FIG. 1 is a perspective view of a rechargeable battery according to the first embodiment.

FIG. 2 is a cross-sectional view of a rechargeable battery shown in FIG. 1.

FIG. 3 is a partially enlarged cross-sectional view of an electrode assembly of a rechargeable battery shown in FIG. 2.

FIG. 4 is an exploded perspective view of a cap plate and a heat dissipating portion of a rechargeable battery shown in FIG. 1.

FIG. 5 is an exploded perspective view of a cap plate and a heat dissipating portion of a rechargeable battery according to a second embodiment.

FIG. 6 is an exploded perspective view of a cap plate and a heat dissipating portion of a rechargeable battery according to a third embodiment.

FIG. 7 is an exploded perspective view of a cap plate and a heat dissipating portion of a rechargeable battery according to a fourth embodiment.

FIG. 8 is a perspective view of a rechargeable battery according to a fifth embodiment.

### DETAILED DESCRIPTION

The present disclosure will be described more fully hereinafter with reference to the accompanying drawings, in which embodiments of the disclosure are shown. As those skilled in the art would realize, the described embodiments may be modified in various different ways, all without departing from the spirit or scope of the present disclosure.

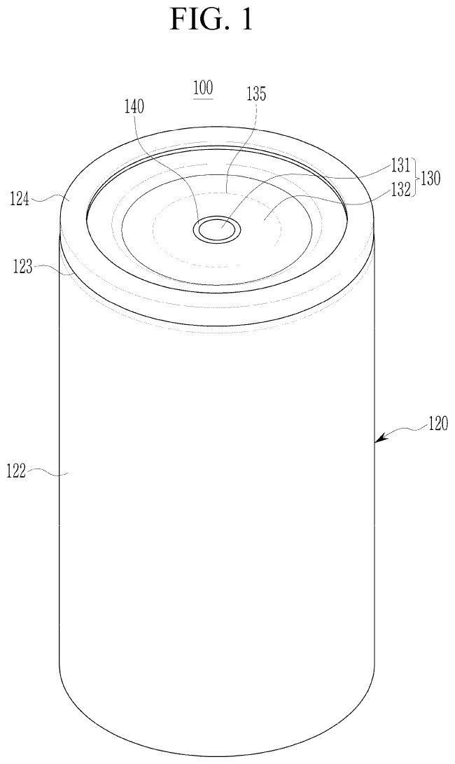

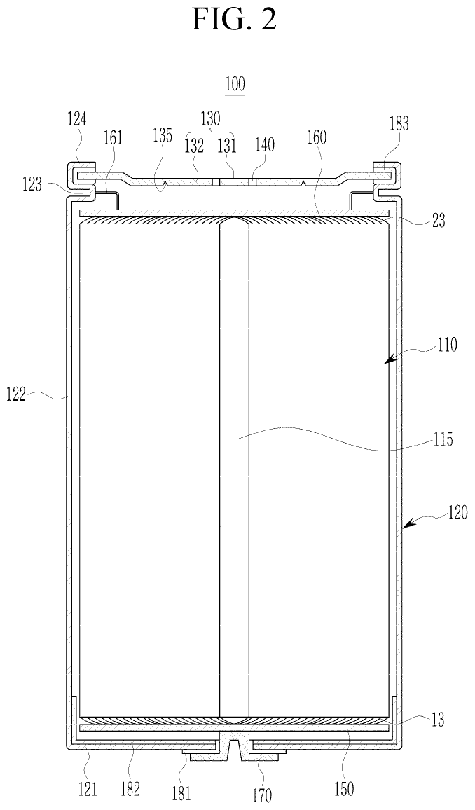

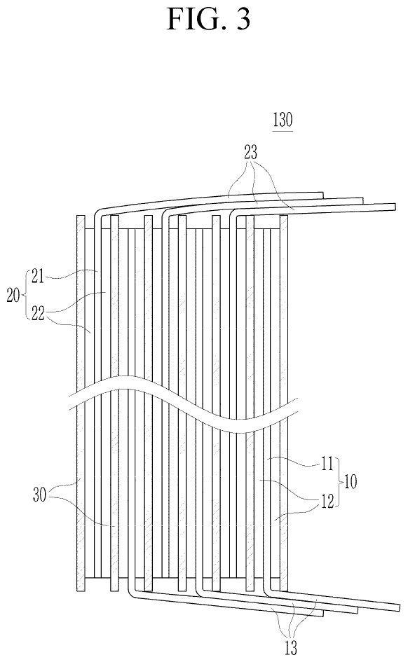

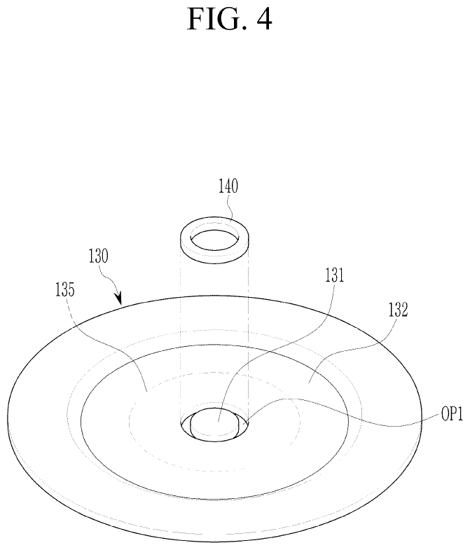

FIG. 1 is a perspective view of a rechargeable battery according to the first embodiment. FIG. 2 is a cross-sectional view of a rechargeable battery shown in FIG. 1. FIG. 3 is a partially enlarged cross-sectional view of an electrode assembly of a rechargeable battery shown in FIG. 2. FIG. 4 is an exploded perspective view of a cap plate and a heat dissipating portion of a rechargeable battery shown in FIG. 1.

Referring to FIG. 1 to FIG. 4, a rechargeable battery 100 of the present embodiment may include an electrode assembly 110, a can 120 that accommodates the electrode assembly 110 in an internal space, a cap plate 130 that is coupled to the end of the opening side of the can 120 to seal the can 120, and a heat dissipating portion 140 installed in the cap plate 130. The rechargeable battery 100 may further include first and second current collecting plates 150 and 160 and a rivet terminal 170.

The electrode assembly 110 may include a first electrode 10, a second electrode 20, and a separator 30. The electrode assembly 110 may have a wound configuration in which a strip-shaped stack is wound in a jelly roll shape. The stack may be assembled by sequentially stacking the first electrode 10, the separator 30, the second electrode 20, and the separator 30, and may be wound multiple times around a winding core 115. In the stack, the positions of the first electrode 10 and the second electrode 20 may be switched.

The first electrode 10 may include a first substrate 11 and a first composite layer 12 positioned on the first substrate 11. The first composite layer 12 may be positioned on the remaining portion of the first substrate 11. In some embodiments, a portion of the first substrate 11, e.g., a lower edge, may be free of the first composite layer 12. In such embodiments, the portion free of the first composite layer 12 has an exposed surface which may be referred to as a first uncoated region 13.

The second electrode 20 may include a second substrate 21 and a second composite layer 22 positioned on the second substrate 21. The second composite layer 22 may be positioned on the remaining portion of the second substrate 21. In some embodiments, a portion of the second substrate 21, e.g., an upper edge, may be free of the second composite layer 22. In such embodiments, the portion free of the second composite layer 22 has an exposed surface which may be referred to as a second uncoated region 23.

In a lithium ion rechargeable battery, the first substrate 11 may include an aluminum foil, and the first composite layer 12 may include a transition metal oxide, a conductive material, a binder, etc. Some examples of suitable transition metal oxides include LiCoO₂, LiNiO₂, LiMn₂O₄, Li(NiCoAl) O₂, LiFePO₄, and Li(NiCoMn)O₂. The second substrate 21 may include a copper foil or nickel foil, and the second composite layer 22 may include graphite, a conductive material, and a binder. The first electrode 10 may be referred to as a positive electrode, and the second electrode 20 may be referred to as a negative electrode.

The separator 30 may include a porous substrate, or may include a porous substrate with a coating layer positioned on at least one surface. The porous substrate may include one or more of polyethylene, polypropylene, polyethylene terephthalate, polypropylene terephthalate, polybutylene terephthalate, polyester, polycarbonate, and/or polyimide. The coating layer may include a binder, and the binder may include a polyvinylidene fluoride-based compound. The separator 30 insulates the first electrode 10 and the second electrode 20 while allowing movement of lithium ions.

The first uncoated region 13 may be bent toward the winding core 115 to overlap the first uncoated region 13 positioned inside, and the first current collecting plate 150 may be fixed to the first uncoated region 13 by a method such as welding. The second uncoated region 23 may also be bent toward the winding core 115 to overlap the second uncoated region 23 positioned inside, and the second current collecting plate 160 may be fixed to the second uncoated region 23 by a method such as welding. Incision lines may be positioned in each of the first and second uncoated regions 13 and 23 to facilitate bending the first and second uncoated regions 13 and 23. The electrode assembly 110 can be accommodated in the internal space of the can 120 together with an electrolyte solution.

The can 120 may have a shape such that one side (e.g., the upper side) is opened so that the electrode assembly 110 and the first and second current collecting plates 150 and 160 may be inserted. The can 120 may include a bottom portion 121 and a side portion 122 connected to the edge of the bottom portion 121. The bottom portion 121 may be referred to as a top portion when the top and bottom of the rechargeable battery 100 are exchanged. The can 120 may be made of, for example, steel, stainless steel, aluminum, or an aluminum alloy.

A terminal hole may be positioned in the center of the bottom portion 121, and the rivet terminal 170 may be installed in the terminal hole in contact with the first insulator 181. The rivet terminal 170 may be combined with the first current collecting plate 150 may be charged to the same polarity as the first electrode 10 by the first current collecting plate 150, and may function as a first terminal (the positive terminal). The first insulator 181 insulates the rivet terminal 170 and the bottom portion 121 and seals the terminal hole to reduce (e.g., prevent) leakage of the electrolyte solution. A second insulator 182 may be placed on one side of the first current collecting plate 150 facing the bottom portion 121.

The cap plate 130 may be positioned on the outside (e.g., the upper side) of the second current collecting plate 160 and may be coupled to the end of the side portion 122 in contact with the third insulator 183. A beading portion 123 and a crimping portion 124 may be positioned in the side portion 122. The beading portion 123 may be a portion of the side portion 122 that is concavely deformed toward the inside of the side portion 122. The crimping portion 124 may be a portion in which the end of the side portion 122 is vertically bent toward the inside of the side portion 122.

Motion of the electrode assembly 110 inside the can 120 may be suppressed by the beading portion 123. The edges of the third insulator 183 and the cap plate 130 may be compressed between the beading portion 123 and the crimping portion 124. The cap plate 130 may be fixed to the can 120 by the beading portion 123 and the crimping portion 124, and may be insulated from the first electrode 10 and the second electrode 20 so as to be electrically non-polarized.

The second current collecting plate 160 may include a connector 161 that is in contact with the inner surface of the side portion 122, for example, the inner surface of the beading portion 123. The can 120 may be charged to the same polarity as the second electrode 20 by the connector 161 and the second current collecting plate 160 and may function as a second terminal (a negative terminal).

A notch groove 135 may be positioned on the inner surface (e.g., the lower surface) of the cap plate 130 to induce breaking and discharge of an internal gas if the internal pressure rises. In some embodiments, the notch groove 135 may have a V-shaped cross-section and may have a circular arc shape on the bottom (when viewing the target object from below). If the internal pressure of the rechargeable battery 100 rises rapidly, the cap plate 130 may be broken from the notch groove 135 and the internal gas may be discharged.

The internal temperature of the rechargeable battery 100 may rise due to various reasons such as a rapid charge and discharge, an external impact, an exposure to high temperature environment, etc., and the internal pressure may rise due to the gasification of the electrolyte solution, etc. In addition, as the rechargeable battery 100 becomes larger and the capacity increases, the internal heat energy generated by the temperature rising can also increase significantly.

For example, assuming a first battery cell with a volume of 24 cm³ and a surface area of 53 cm², and a second battery cell with a volume of 133 cm³ and a surface area of 130 cm², the second battery cell has a volume approximately 5.5 times greater than that of the first battery cell and the second battery cell has surface area approximately 2.5 times greater than that of the first battery cell.

Because the second battery cell has the large volume, heat generation may progress slowly at first, but after a certain point when internal self-heating begins, it has the heat generation energy of approximately 5.5 times that of the first battery cell. However, because the surface area that can discharge this heat energy to the outside has only increased by approximately 2.5 times, the temperature can rise rapidly. In other words, it may be more difficult to dissipate heat from the large-sized second battery cell as compared to the smaller-sized first battery cell.

Since the rechargeable battery can begin to self-heat at a certain temperature, it may be important to discharge the heat energy away from the battery cell. The rechargeable battery 100 of the present embodiment discharges the heat energy away from the battery cell using the heat dissipating portion 140 described below if the temperature rises, and then, if the pressure suddenly increases, the pressure is relieved using the notch groove 135 described above.

At least one opening may be positioned in the cap plate 130, and the heat dissipating portion 140 may fill this opening to be sealed. The heat dissipating portion 140 may be positioned at a predetermined distance from the notch groove 135, and may include a polymer material melted in a predetermined temperature range to discharge heat and gas inside the rechargeable battery 100 at a predetermined temperature condition.

In the rechargeable battery 100 of the present embodiment, the cap plate 130 may be composed of two parts (e.g., a first part 131 and a second part 132) separated by a first opening OP1. The heat dissipating portion 140 may be filled in the first opening OP1 to seal the first opening OP1 and to simultaneously, integrally combine the first part 131 and the second part 132. For example, the cap plate 130 may be composed of two parts 131 and 132 with the heat dissipating portion 140 positioned in between.

The first part 131 may have a disk shape and may be positioned in the center of the cap plate 130. The heat dissipating portion 140 may have a round ring shape surrounding the first part 131 and may have a constant width along the circumferential direction. The thickness of the heat dissipating portion 140 may be equal to or smaller than the thickness of the cap plate 130. The thickness of the heat dissipating portion 140 may be appropriately determined by considering the sealing function of the heat dissipating portion 140 and the heat dissipation effect by melting. The second part 132 may be shaped like a disk with an empty center. The notch groove 135 may be placed in a circular arc shape on the second part 132.

The heat dissipating portion 140 may include a polymer material having a melting temperature of approximately 80° C. to 130° C. For example, the heat dissipating portion 140 may include one or more polymers chosen from polystyrene (PS), low density polyethylene (LDPE), high density polyethylene (HDPE), and acrylonitrile butadiene styrene (ABS).

The heat dissipating portion 140 is melted when the surrounding temperature of the rechargeable battery 100 reaches a melting temperature thereof and gradually discharges the internal heat of the rechargeable battery 100. Then, since the heat dissipating portion 140 occupies a small area in the cap plate 130, it functions to gradually discharge the internal heat of the rechargeable battery 100 rather than all at once during the melting.

If the melting temperature of the heat dissipating portion 140 is less than 80° C., the heat dissipating portion 140 may be melted under normal use conditions, and in this case, the function of the rechargeable battery may be lost. If the temperature of the heat dissipating portion 140 exceeds 130° C., the hot-box characteristic, which is one of the safety evaluation items for the rechargeable batteries, may not be satisfied.

The hot-box test is an evaluation method that places the rechargeable battery in a chamber, raises the temperature of the chamber to 130° C., and maintains it for 30 minutes. The rechargeable battery 100 of the present embodiment equipped with the heat dissipating portion 140 may reduce (e.g., prevent) the ignition and explosion of the rechargeable battery 100 by discharging the internal heat energy through the melting of the heat dissipating portion 140 within the chamber.

The rechargeable battery 100 of the present embodiment may gradually discharge the internal heat by the melting of the heat dissipating portion 140 when exposed to a high temperature outside the normal range, and when a rapid increase in the temperature and pressure occurs. For example, the cap plate 130 may be broken (e.g., along the notch groove 135), thereby discharging a large amount of heat at once. The cap plate 130 may be broken after the heat dissipating portion 140 is melted, or when a rapid increase in the temperature and pressure occurs before the heat dissipating portion 140 is melted.

The breaking pressure of the cap plate 130 due to the notch groove 135 may be approximately 10 kgf/cm² to 30 kgf/cm². If the breaking pressure is less than 10 kgf/cm², there is a risk that the cap plate 130 may be broken under normal use conditions of the rechargeable battery, and if the breaking pressure exceeds 30 kgf/cm², there is a risk of ignition and explosion of the rechargeable battery due to delayed breaking of the cap plate 130. According to the above-mentioned pressure range, the rupture of the cap plate 130 may be reduced (e.g., prevented) in the normal use environment of the rechargeable battery 100, while the premature rupture of the cap plate 130 may be induced when the pressure rises abnormally.

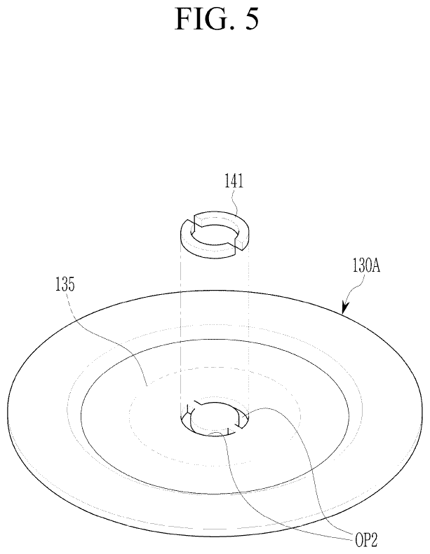

FIG. 5 is an exploded perspective view of a cap plate and a heat dissipating portion of a rechargeable battery according to a second embodiment. The rechargeable battery of the second embodiment has the same or similar configuration as the first embodiment described above, except for differences described below.

Referring to FIG. 5, in the present embodiment of the rechargeable battery, at least two second openings OP2 in a circular arc shape may be positioned on the cap plate 130A, and the heat dissipating portion 141 may be filled in the second opening OP2 to seal the second opening OP2. For example, in the cap plate 130A, at least two heat dissipating portions 141 may be formed in a circular arc shape positioned at a distance from each other.

The plurality of heat dissipating portion 141 may be arranged along a circle of a specific radius centered on the central point of the cap plate 130A. The plurality of heat dissipating portions 141 may have the same length along the circumferential direction and may be positioned at the same distance from each other along the circumferential direction. In FIG. 5, two heat dissipating portions 141 are shown, but the number of the heat dissipating portions 141 is not limited to the example shown. The notch groove 135 may be positioned outside the plurality of heat dissipating portions 141.

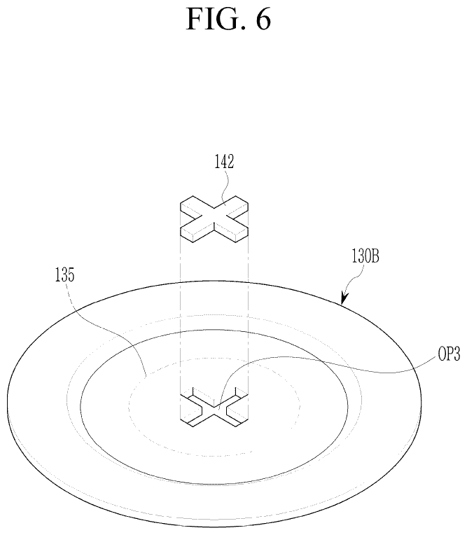

FIG. 6 is an exploded perspective view of a cap plate and heat dissipating portion of a rechargeable battery according to a third embodiment. The rechargeable battery of the third embodiment has the same or similar configuration as the first embodiment described above, except for differences described below.

Referring to FIG. 6, in the rechargeable battery of the present embodiment, a cross shape opening OP3 may be positioned on the cap plate 130B, and a heat dissipating portion 142 may be filled in the cross shape opening OP3 to seal the cross shape opening OP3. The heat dissipating portion 142 may have a cross shape, and the center of the heat dissipating portion 142 may be positioned on the center point of the cap plate 130B. The notch groove 135 may be positioned on the outside of the heat dissipating portion 142.

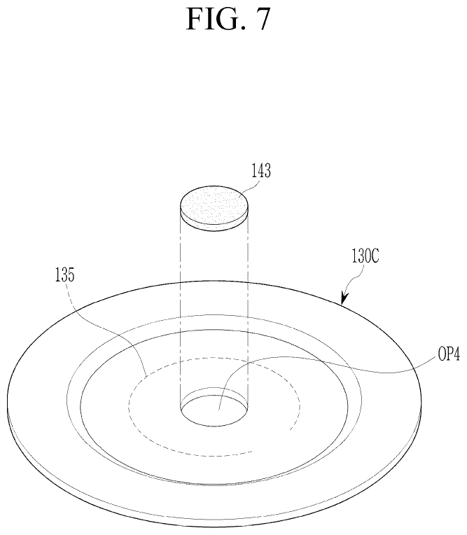

FIG. 7 is an exploded perspective view of a cap plate and a heat dissipating portion of a rechargeable battery according to a fourth embodiment. The rechargeable battery of the fourth embodiment has the same or similar configuration as the first embodiment described above, except for differences described below.

Referring to FIG. 7, in the rechargeable battery of the present embodiment, a circular opening OP4 may be positioned on the cap plate 130C, and a heat dissipating portion 143 may be filled in the circular opening OP4 to seal the circular opening OP4. The heat dissipating portion 143 may be circular, and the center of the heat dissipating portion 143 may be positioned on the center point of the cap plate 130C. The notch groove 135 may be positioned on the outside of the heat dissipating portion 143.

The cap plate 130 of the above-described first embodiment may be divided into two parts 131 and 132, but the cap plates 130A, 130B, and 130C of the second to fourth embodiment may be a single part. The planar shapes of the heat dissipating portions 140, 141, and 142, and 143 are not limited to the above-described embodiments, and may be altered in various manners. For example, the heat dissipating portion may be implemented in various shapes (e.g., within a range that maintains a certain distance from the notch groove 135 and does not deteriorate the strength of the cap plate 130 below an appropriate level).

In the above-described embodiments, at least one heat dissipating portion 140, 141, 142, and 143 may be positioned at the center of the cap plate 130. When the temperature of the electrode assembly 110 rises due to various causes, heat from the outer portion of the electrode assembly 110 may be released to the outside through the side portion 122 of the can 120, but heat from the center of the electrode assembly 110 may not be released and may be accumulated. The heat dissipating portions 140, 141, 142, and 143 positioned at the center of the cap plate 130 may discharge heat from the center of the electrode assembly 110 to the outside during the melting.

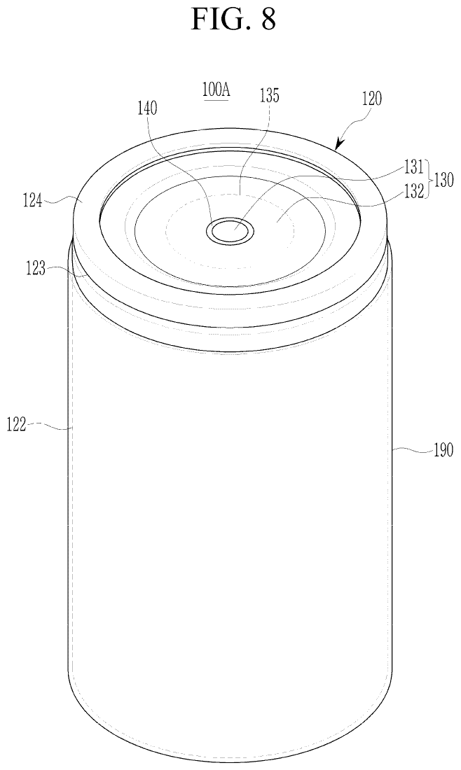

FIG. 8 is a perspective view of a rechargeable battery according to a fifth embodiment. The rechargeable battery of the fifth embodiment has the same or similar configuration as any one of the first to fourth embodiments described above, except for differences described below. FIG. 8 shows the case where the heat dissipating portion 140 of the first embodiment is provided as an example.

Referring to FIG. 8, a rechargeable battery 100A of the present embodiment may include a heat dissipation film 190. The heat dissipation film 190 may be attached to the outer surface of the side portion 122 excluding the beading portion 123 and the crimping portion 124. The side portion 122 to which the heat dissipation film 190 is attached may more quickly dissipate the heat of the electrode assembly to the outside when the electrode assembly generates heat.

The heat dissipation film 190 may include at least one heat dissipation layer and a plurality of polymer layers that protect the heat dissipation layer. For example, the heat dissipation film 190 may include a stacking structure of a polymer layer, a heat dissipation layer, and a polymer layer, but is not limited to this example.

The heat dissipation layer may be made of a thermal conductivity material such as aluminum, copper, or carbon nanotubes, and may radiate heat transferred from the can 120 to the outside. The polymer layer, for example, may include one or more polymers chosen from polyimide, polyethylene terephthalate, oriented polystyrene, oriented polypropylene, and polyethylene naphthalate, and may provide an insulating function to the heat dissipation film 190.

A plurality of rechargeable batteries in the above-described embodiments may be gathered together to form a battery module. The plurality of rechargeable batteries may be connected in series, in parallel, or in a combination of series and in parallel by a busbar, and may be used as a power source for transportation vehicles such as electric vehicles and hybrid vehicles. The rechargeable battery of the above-described embodiments may improve the high temperature safety of the battery module by improving heat dissipation characteristics.

While this disclosure has been described in connection with what is presently considered to be practical exemplary embodiments, it is to be understood that the disclosure is not limited to the disclosed embodiments, but, on the contrary, is intended to cover various modifications and equivalent arrangements included within the spirit and scope of the appended claims.

What is claimed is:

1. A rechargeable battery comprising:
an electrode assembly including a first electrode, a separator, and a second electrode;
a can accommodating the electrode assembly in an internal space;
a cap plate coupled to an end of an open side of the can to seal the can, the cap plate having a notch groove and at least one opening positioned at a distance from the notch groove; and
a heat dissipating portion that at least partially fills the at least one opening in the cap plate.

2. The rechargeable battery of claim 1, wherein
the cap plate includes a first part, a second part, the at least one opening positioned between the first part and the second part, and
the heat dissipating portion seals the at least one opening and integrally combines the first part and the second part.

3. The rechargeable battery of claim 2, wherein
the first part is positioned in a center of the cap plate,
the heat dissipating portion is formed in a ring shape surrounding the first part, and
the second part surrounds the heat dissipating portion.

4. The rechargeable battery of claim 3, wherein
the notch groove is positioned in the second part.

5. The rechargeable battery of claim 1, wherein
the cap plate includes a plurality of the at least one opening, with the openings being arranged in a circular arc shape, and
the heat dissipating portion includes a plurality of heat dissipating portions to seal each of the plurality of openings.

6. The rechargeable battery of claim 5, wherein
the plurality of heat dissipating portions is arranged along a circle centered on a center point of the cap plate, and
the notch groove is positioned to surround the plurality of heat dissipating portions.

7. The rechargeable battery of claim 1, wherein
the at least one opening is a cross-shaped opening that is formed in the cap plate, and
the heat dissipating portion seals the cross-shaped opening.

8. The rechargeable battery of claim 7, wherein
a center of the heat dissipating portion coincides with a center of the cap plate, and
the notch groove is positioned to surround the heat dissipating portion.

9. The rechargeable battery of claim 1, wherein
the at least one opening is a circular opening that is formed in the cap plate, and
the heat dissipating portion seals the circular opening.

10. The rechargeable battery of claim 9, wherein
a center of the heat dissipating portion coincides with a center of the cap plate, and
the notch groove is positioned to surround the heat dissipating portion.

11. The rechargeable battery of claim 1, wherein
the heat dissipating portion includes a polymer material that is melted at 80° C. to 130° C.

12. The rechargeable battery of claim 11, wherein
the heat dissipating portion includes one or more polymers chosen from polystyrene (PS), low density polyethylene (LDPE), high density polyethylene (HDPE), and acrylonitrile butadiene styrene (ABS).

13. A rechargeable battery comprising:
an electrode assembly including a first electrode, a separator, and a second electrode;
a can including a bottom portion and a side portion, the can accommodating the electrode assembly in an internal space surrounded by the bottom portion and the side portion;
a cap plate coupled to an end of the side portion to close the can, the cap plate including at least one opening at least partially filled with a polymer material and a notch groove surrounding the opening; and
a heat dissipation film attached to the outer surface of the side portion.

14. The rechargeable battery of claim 13, wherein
the polymer material is melted at 80° C. to 130° C.

15. The rechargeable battery of claim 14, wherein
the polymer material includes one or more polymers chosen from polystyrene (PS), low density polyethylene (LDPE), high density polyethylene (HDPE), and acrylonitrile butadiene styrene (ABS).

16. The rechargeable battery of claim 13, wherein
The at least one opening is provided at a center of the cap plate in a circular ring shape, a cross shape, or a circle shape.

17. The rechargeable battery of claim 13, wherein
the at least one opening includes a plurality of openings spaced apart from each other along a circle.

18. The rechargeable battery of claim 13, wherein
the heat dissipation film includes at least one heat dissipation layer and a plurality of polymer layers.

19. The rechargeable battery of claim 18, wherein
the heat dissipation layer includes one or more of aluminum, copper, and carbon nanotubes, and
each of the plurality of polymer layers includes one or more of polymers chosen from polyimide, polyethylene terephthalate, oriented polystyrene, oriented polypropylene, and polyethylene naphthalate.

20. The rechargeable battery of claim 1, wherein the heat dissipating portion seals the at least one opening in the cap plate.
